(19) United States
(12) Patent Application Publication
(10) Pub. No.: US 2026/0240721 A1
(43) Pub. Date: Aug. 20, 2026

(54) DRIVING DEVICE FOR MASSAGER AND MASSAGER

(71) Applicant: Dongguan Lingding Technology Co., Ltd, Dongguan (CN)

(72) Inventor: Kui JI, Dongguan (CN)

(73) Assignee: Dongguan Lingding Technology Co., Ltd, Dongguan (CN)

(21) Appl. No.: 19/646,968

(22) Filed: Apr. 14, 2026

Related U.S. Application Data
(63) Continuation of application No. 19/017,752, filed on Jan. 12, 2025.

(30) Foreign Application Priority Data
Dec. 11, 2024 (CN) 202423065458.3

(51) Int. Cl. A61H 23/02; A61H 23/00

(52) U.S. Cl. CPC A61H 23/0254; A61H 23/006; A61H 2201/0153; A61H 2201/0165; A61H 2201/149

(57) ABSTRACT

A driving device for a massager includes a bracket, a power mechanism, a connecting rod mechanism and a swing rod mechanism. The connecting rod mechanism includes a connecting rod seat, a driving connection rod and a driven connection rod which are rotatably connected in sequence. A first end of the swing rod mechanism is rotatably connected to the bracket, and a rear end of the swing rod mechanism is rotatably connected to the driven connection rod. The driven connection rod carries out a linear reciprocating motion under the driving action of the driving connection rod and the limiting action of the swing rod mechanism. The massager using the driving device of the present disclosure can guide the driven connection rod without a bushing. The present disclosure also provides a massager having the driving device.

### CROSS-REFERENCE TO RELATED APPLICATIONS

This application is a continuation of U.S. Patent Application No. 19/017,752, filed on January 12, 2025, which claims priority to Chinese Patent Application No.202423065458.3, filed on December 11, 2024. The disclosures of the above-mentioned applications are hereby incorporated by reference in their entireties.

### TECHNICAL FIELD

The disclosure relates to the technical field of massage devices, and more particularly, to a driving device for a massager and a massager.

### BACKGROUND

A retractable massager is widely popular among users by driving a high-frequency retractable action of a massage head on users’ body to relax the muscles, thereby eliminating muscle fatigue. Currently, the retractable massager on the market includes a bushing arranged in the housing for guiding a piston. The piston for driving the retractable movement of the massage head is inserted in the bushing, such that when the massager is in use, the piston stably reciprocates along the axial direction of the bushing under the driving of the driving device and the guiding of the bushing. Under the above structure, the bushing usually has to be oiled to reduce friction. However, the oil on the bushing can easily leak in such a high-speed operation. When the bushing is out of oil for lubrication, due to constant friction between the piston and the bushing during the reciprocating process, the bushing becomes hot and may be worn out easily, which further results in a lot of noise. After being used for a certain period, the gap between the bushing and the piston is unavoidably enlarged due to the heat and wear of the bushing, which further leads to larger noise and poor stability during the movement of the piston. As a result, the massager cannot work normally and the life of the massager is relatively short. Moreover, the stroke of the piston can not be too long; the longer the stroke, the more easily the lubrication coating on the bushing may fall off, which thus may lead to excessive heat and burn off the bushing.

### SUMMARY

The present disclosure provides a driving device for a massager and a massager.

The driving device for a massager in the present disclosure includes a bracket, a connecting rod mechanism, a power mechanism, and a swing rod mechanism. The connecting rod mechanism includes a connecting rod seat, a driving connection rod, and a driven connection rod; wherein a rotation axis of the connecting rod seat is parallel to a second axial direction; a first end of the driving connection rod is rotatably connected to the connecting rod seat, a second end of the driving connection rod is rotatably connected to the driven connection rod, and an axis of each rotation node of the first end and the second end of the driving connection rod is parallel to the second axial direction. The power mechanism is arranged on the bracket and connected to the connecting rod seat for driving the connecting rod seat to rotate. The swing rod mechanism includes at least two swing rods rotatably connected in sequence; wherein a front end of the swing rod mechanism is rotatably connected to the bracket, a rear end of the swing rod mechanism is rotatably connected to the driven connection rod, and an axis of each rotation node of the swing rod mechanism is parallel to a third axial direction. Wherein the power mechanism drives the connecting rod seat to rotate and thus drives the first end of the driving connection rod to rotate around the rotation axis of the connecting rod seat, thereby driving the driving connection rod to swing; under the driving action of the second end of the driving connection rod and the limiting action of the swing rod mechanism, the driven connection rod reciprocates in a first axial direction; and the first axial direction, the second axial direction, and the third axial direction are mutually perpendicular to each other.

In some embodiments, the rotation axis of the connecting rod seat is in the same plane as the axis of the rotation node of the second end of the driving connection rod, and is parallel to the first axial direction; and/or, in the first axial direction, the rotation node of the second end of the driving connection rod is located directly behind the driven connection rod.

The massager in the present disclosure includes a housing and the above-described driving device. The driving device is arranged in the housing and the bracket is fixed to the housing. An opening is formed in one end of the housing close to the driven connection rod, allowing a massage head to be mounted on the driven connection rod.

In the technical solution of the present disclosure, the driving device for a massager includes the bracket, the power mechanism arranged in the bracket, the connecting rod mechanism, and swing rod mechanism. The connecting rod mechanism includes the connecting rod seat, the driving connection rod, and the driven connection rod. The power mechanism is connected to the connecting rod seat for driving the connecting rod seat to rotate around the rotation axis parallel to the second axial direction. The driven connection rod is used for connecting a massage head. The swing rod mechanism includes at least two swing rods rotatably connected in sequence. A first end of the swing rod mechanism is rotatably connected to the bracket, a rear end of the swing rod mechanism is rotatably connected to the driven connection rod. An axis of each rotation node of both ends of the driving connection rod is parallel to the second axial direction and an axis of each rotation node of the swing rod mechanism is parallel to a third axial direction.

In this way, the connecting rod seat drives the driving connection rod to swing when the power mechanism drives the connecting rod seat to rotate, such that the driving connection rod generates a driving force on the driven connection rod. Under the movement limiting and stabilizing effect of the swing rod mechanism, the driven connection rod is guaranteed to carry out the reciprocating motion along the first axial direction stably.

Compared to existing technologies, the massager using the driving device of the present disclosure can guide the driven connection rod without a bushing, avoiding the problems of high noise, poor motion stability, short service life, and short stroke associated with the use of bushings. Moreover, motion resistance is low due to the rotatably-connected nodes of the swing rod mechanism, which allows the reciprocating motion of the driven connection rod to be smoother and the driven connection rode to have a longer service life. Therefore, the service life of the massager and the stroke of the massage head are both effectively improved.

### BRIEF DESCRIPTION OF THE DRAWINGS

To more clearly illustrate the technical solutions in the present disclosure or prior art, a brief description of the accompanying drawing to be used in the description of the embodiments or prior art will be given below. The drawing described below is obviously just an embodiment of the present disclosure. For ordinary technicians in this field, other drawings can be obtained based on the drawing without doing creative work.

FIG. 1 is a schematic view of a driving device of a massager in accordance with an embodiment of the present disclosure.

FIG. 2 is a schematic view of a driving device of a massager in accordance with another embodiment of the present disclosure.

FIG. 3 is a schematic view of a driving device of a massager in accordance with yet another embodiment of the present disclosure.

FIG. 4 is a schematic view of a massager using the driving device of the present disclosure.

FIG. 5 is a partially schematic view of the massager of FIG. 1.

FIG. 5a is a partially schematic view of a housing of the massager of FIG. 5.

FIG. 6 is a schematic view of the driving device of FIG. 1 from another viewing angle.

FIG. 7 is an exploded view of the driving device of FIG. 1.

FIG. 7a is partially cross-sectional view of a bearing structure of the driving device in accordance with an embodiment of the present disclosure.

FIG. 8 is a schematic view of a driven connection rod of the driving device in accordance with an embodiment of the present disclosure.

FIG. 9 is a schematic view of a driving connection rod of the driving device in accordance with an embodiment of the present disclosure.

FIG. 10 is a schematic view of the massager of FIG. 4 from another viewing angle.

FIG. 11 is a schematic view of a massager using the driving device of the present disclosure.

FIG. 11a is a schematic view of a massager using the driving device of the present disclosure.

FIG. 12 is a schematic view of a massager using the driving device of the present disclosure.

FIG. 13 is a schematic view of a massager in accordance with an embodiment of the present disclosure.

FIG. 14 is a partially schematic view of the massager of FIG. 13.

FIG. 15 is a partially schematic view of the massager of FIG. 13.

FIG. 16 a partially schematic view of a housing of the massager of FIG. 13.

FIG. 17 is a schematic view of a driving device of a massager in accordance with yet another embodiment of the present disclosure.

FIG. 18 is a schematic view of a driving device of a massager in accordance with yet another embodiment of the present disclosure.

### DETAILED DESCRIPTION OF THE EMBODIMENTS

To make the purpose, technical solution, and advantages of the present disclosure clearer, the technical solution of the present disclosure will be clearly and completely described below in conjunction with the drawings of the present disclosure. The described embodiments are part of the embodiments of the present disclosure, not all of the embodiments. Based on the embodiments of the present disclosure, all other embodiments obtained by ordinary technicians in this field without creative work are within the scope of protection of the present disclosure.

It should be noted that all directional indications (such as up, down, left, right, forward, and backward) in the embodiments of the present disclosure are used only for explaining the relative positional relationship, movement, etc., among the various components in a particular attitude (as shown in the accompanying drawings), and the directional indications are changed accordingly if the attitude is changed.

Furthermore, the descriptions of “first”, “second”, and the like in this application are used only for descriptive purposes and are not to be construed as indicating or implying their relative importance, or as implicitly specifying the number of technical features to be indicated. Thus, a feature defined as “first” or “second” may include at least one such feature, either explicitly or implicitly. In addition, “and/or” in the whole text includes three solutions, and in the case of A and/or B, for example, it includes the A technical solution, the B technical solution, and the technical solution in which A and B are satisfied at the same time; furthermore, the technical solutions of the various embodiments can be combined with each other, but it must be on the basis that the person of ordinary skill in the field is able to realize it. When the combination of technical solutions is contradictory or unachievable, it should be considered that the combination of such technical solutions does not exist and is not within the scope of protection of the present disclosure.

The present disclosure provides a driving device for a massager and a massager, the massager is mainly used for body massage. The driving device includes a bracket, a power mechanism, a connecting rod mechanism, and a swing rod mechanism. The power mechanism is arranged on the bracket. The connecting rod mechanism includes a connecting rod seat, a driving connection rod, and a driven connection rod which are rotatably connected in sequence. The driven connection rod is used for installing a massage head. The swing rod mechanism includes at least two swing rods which are rotatably connected in sequence, a first end of the swing rod mechanism is rotatably connected to the bracket, and a rear end of the swing rod mechanism is rotatably connected to the driven connection rod. When the driving device operates, the power mechanism rotates the connecting rod seat to drive the driving connection rod to swing, such that the driving connection rod transmits the driving force to the driven connection rod. The driven connection rod carries out a linear reciprocating motion under the driving action of the driving connection rod and the limiting action of the swing rod mechanism, ensuring the massager to perform reciprocating motion to provide the massage. The driving device of the present disclosure can guide the swing rod mechanism through the driven connection rod to ensure the stable reciprocating motion of the driven connection rode, thus, the massager using the driving device of the present disclosure can guide the driven connection rod without a bushing, which avoids the problems of high noise, poor movement stability, and short service life. Furthermore, motion resistance is low due to the rotatably-connected nodes of the swing rod mechanism, which allows the reciprocating motion of the driven connection rod to be smoother and the driven connection rode to have a longer service life. Therefore, the service life of the massager and the stroke of the massage head are both effectively improved.

The specific structure of the driving device of the massager of the present disclosure will be described in detail in the following in conjunction with the accompanying drawings.

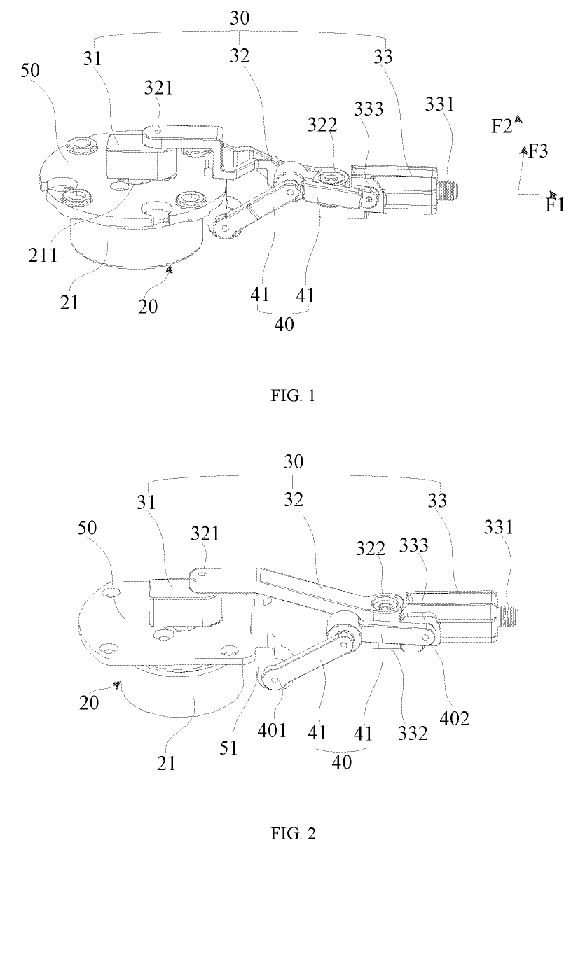

Referring to FIGS. 1 to 6, in this embodiment of the present disclosure, the driving device includes a bracket 50, a power mechanism 20, a connecting rod mechanism 30, and at least one swing rod mechanism 40, and the power mechanism 20 is mounted on the bracket 50. In the embodiment, the driving device includes only one swing rod mechanism 40; in other embodiments, the number of the swing rod mechanism 40 may be two, three, or more.

In the description of this embodiment, the directions include a first axial direction F1, a second axial direction F2, and a third axial direction F3, and these three axial directions are mutually perpendicular to each other; that is, any two of the three directions are perpendicular to each other (i.e., the first axial direction F1 is perpendicular to the second axial direction F2, the first axial direction F1 is perpendicular to the third axial direction F3 and the second axial direction F2 is perpendicular to the third axial direction F3). It can be understood that the first axial direction F1, the second axial direction F2 and the third axial direction F3 are the X-axis direction, the Y-axis direction and the Z-axis direction in the same XYZ coordinate three-dimension system, respectively.

Referring to FIG. 1, the connecting rod mechanism 30 includes a connecting rod seat 31, a driving connection rod 32, and a driven connection rod 33. The connecting rod seat 31 is connected to the power mechanism 20. The power mechanism 20 is used to rotate the connecting rod seat 31. A rotation axis of the connecting rod seat 31 is parallel to the second axial direction F2, that is, the connecting rod seat 31 rotates around the rotation axis thereof when the power mechanism 20 is in operation. A first end 321 of the driving connection rod 32 is rotatably connected to the connecting rod seat 31, and a second end 322 of the driving connection rod 32 is rotatably connected to the driven connection rod 33. An axis of each rotation node of the first end and the second end of the driving connection rod 32 is parallel to the second axial direction F2 (the axis of each rotation node of the two ends of the driving connection rod 32 refers to the rotation axis of each rotatable connection position of the two ends of the driving connection rod 32). Thus, the driven connection rod 33 can only move in a plane perpendicular to the second axial direction F2. An end of the driven connection rod 33 away from the connecting rod seat 31 is used for installing and connecting a massage head, such that the massage head follows the movement of the driven connection rod 33. The massage head and the driven connection rod 33 are detachably connected together, or the massage head can also be integrally formed with the driven connection rod 33. In the present embodiment, the massage head and the driven connection rod 33 are detachably connected together, such that the driven connection rod 33 can be equipped with massage heads of different shapes, sizes, or functions, to realize more diversified massage, and can better meet different needs of different users.

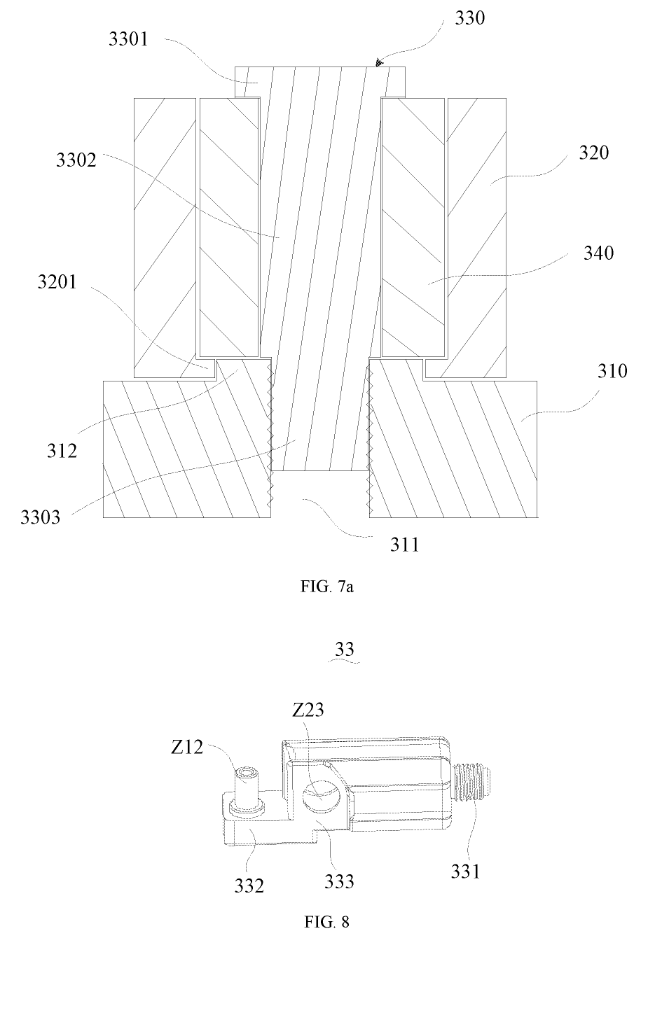

The detachable connection between the driven connection rod 33 and the massage head can be realized in various ways, such as threaded connection, socket connection, plug connection, and snap connection. Also referring to FIGS. 7 and 8, in some embodiments, an end of the driven connection rod 33 away from the connecting rod seat 31 is provided with an interface 331 for mounting the massage head, which may be a threaded connector (e.g., a stud, a screw hole), a socket, a bayonet, and the like. For example, the interface 331 can be a stud. When the massage head is assembled, the stud can be threadly connected into the screw hole in the massage head; when the massage head needs to be replaced by a new one, the current massage head can be unscrewed from the driven connection rod 33.

Referring to FIGS. 1, 6, and 7, the swing rod mechanism 40 includes at least two swing rods 41 rotatably connected in sequence. The swing rod mechanism 40 includes a front end 401 and a rear end 402. The front end 401 of the swing rod mechanism 40 refers to the end of the first swing rod 41 that is not connected to another swing rod 41, and the rear end 402 of the swing rod mechanism 40 refers to the end of the last swing rod 41 of the swing rod mechanism 40 that is not connected to another swing rod 41. The front end 401 of the swing rod mechanism 40 is rotatably connected to the bracket 50 (the front end 401 of the swing rod mechanism 40 is rotatably connected to the bracket 50 directly; or the front end 401 of the swing rod mechanism 40 is rotatably connected to an intermediate member fixed to the bracket 50), and the rear end 402 of the swing rod mechanism 40 is rotatably connected to the driven connection rod 33. An axis of each rotation node of the swing rod mechanism 40 is parallel to the third axial direction F3(the axis of each rotation node of the swing rod mechanism 40 refer to the rotation axis of each rotatable connection position of the swing rod mechanism 40), such that each swing rod 41 of the swing rod mechanism 40 can only move in a plane perpendicular to the third axial direction F3. In the present embodiment, the swing rod mechanism 40 includes two swing rods 41 rotatably connected in sequence; in other embodiments, the number of swing rod 41 of the swing rod mechanism 40 may also be three, four or more. The swing rods 41 of the swing rod mechanism 40 may be of the same length or of different lengths, which is determined according to the structural design requirements of the interior of the housing 10.

When the driving device of the massager of this embodiment is in operation, the power mechanism 20 drives the connecting rod seat 31 to rotate, and the rotation of the connecting rod seat 31 drives the first end 321 of the driving connection rod 32 to rotate around the rotation axis of the connecting rod seat 31, thereby driving the driving connection rod 32 to swing (i.e., the axis of the rotation node of the first end 321 of the driving connection rod 32 and the rotation axis of the connecting rod seat 31 are separated by a certain distance, such that the first end 321 of the driving connection rod 32 performs an eccentric motion with the rotation of the connecting rod seat 31). The second end 322 of the driving connection rod 32 is rotatably connected to the driven connection rod 33; since the driven connection rode 33 is also rotatably connected to the rear end 402 of the swing rod mechanism 40, the driven connection rod 33 is limited by the swing rod mechanism 40 to only move in a plane perpendicular to the third axial direction F3, such that the second end 322 of the driving connection rod 32 cannot follow the swinging of the first end 321 and converts the force transmitted by the swinging of the first end 321 of the driving connection rod 32 into a driving force along the first axial direction F1. Therefore, under the limiting and stabilizing action of the swing rod mechanism 40, the driven connection rod 33 is driven by the driving connection rod 32 to reciprocate along the first axial direction F1, and the massage head mounted on the driven connection rod 33 follows the driven connection rod 33 to reciprocate along the first axial direction F1 to realize the massage action.

The driving device of the massager of the present embodiment includes the bracket 50, the power mechanism 20 mounted on the bracket 50, the connecting rod mechanism 30, and at least one swing rod mechanism 40. The connecting rod mechanism 30 includes the connecting rod seat 31, the driving connection rod 32, and the driven connection rod 33 rotatably connected in sequence, and the connecting rod seat 31 is connected to the power mechanism 20 for driving the connecting rod seat 31 to rotate about the axis parallel to the second axial direction F2. The driven connection rod 33 is used to connect the massage head. The swing rod mechanism 40 includes at least two swing rods 41 rotatably connected in sequence, the front end 401 of the swing rod mechanism 40 is rotatably connected to the bracket 50, and the rear end 402 of the swing rod mechanism 40 is rotatably connected to the driven connection rod 33. The axis of each rotation node of the ends of the driving connection rod 32 is parallel to the second axial direction F2, and the axis of each rotation node of the swing rod mechanism 40 is parallel to the third axial direction F3. In this way, when the power mechanism 20 drives the connecting rod seat 31 to rotate, the connecting rod seat 31 drives the driving connection rod 32 to swing, such that the driving connection rod 32 generates a driving force on the driven connection rod 33. Under the movement stabilizing action and limiting action of the swing rod mechanism 40, the driven connection rod 33 is allowed to stably reciprocate along the first axial direction F1. Compared with the existing technologies, the massager using the driving device of this embodiment can guide the driven connection rod 33 without a bushing, which avoids the problems of high noise, poor motion stability, short service life, and short stroke. Moreover, the motion resistance is low due to the rotatably-connected nodes of the swing rod mechanism 40, which allows the reciprocating motion of the driven connection rod 33 to be smoother and the driven connection rode 33 to have a longer service life, thus effectively improving the service life of the massager and the stroke of the massage head.

It should be noted that there are many ways for the power mechanism 20 to drive the connecting rod seat 31, which will be described separately below.

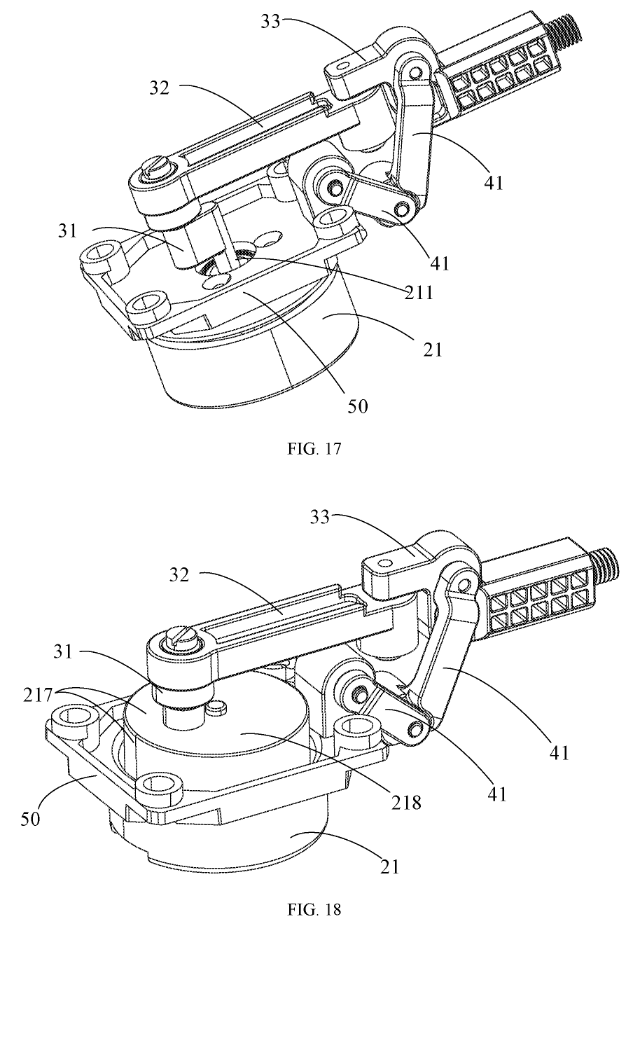

Referring to FIG. 17, the connecting rod seat 31 can cooperate with the power mechanism at many positions. Taking the power mechanism 30 including a motor 21 as an example, in some embodiments, the connecting rod seat 31 may be detachably connected to an output shaft 211 of the motor 21 (the two components are independent and are assembled in a detachable manner). In some embodiments, the connecting rod seat 31 may also be integrally formed with the output shaft 211 (for example, the two components may be integrally formed by integral casting, double-shot molding or the like, or may be integrated by welding or the like). In this way, the connecting rod seat 31 moves with the rotation of the output shaft 211, and the driving connection rod 32 moves with the rotation of the connecting rod seat 31.

Referring to FIG. 18, in some embodiments, the connecting rod seat 31 may also be fixedly connected to a rotor of the motor 21 (either directly or indirectly). Alternatively, in some embodiments, if a motor housing 217 of the motor 21 is fixedly connected to the rotor of the motor 21 or the output shaft 211, the connecting rod seat 31 may also be fixedly connected to the motor housing 217 (in some embodiments, the connecting rod seat 31 may also be integrally formed with the motor housing 217), and the motor housing 217 rotates with the operation of the motor. The connecting rod seat 31 can be connected to the motor housing 217 at many positions. For example, the connecting rod seat 31 can be arranged at an end portion of the motor housing 217. In an embodiment, the housing 217 has an end plate 218, and the end plate 218 is fixedly connected to the output shaft 211 and rotates with the rotation of the output shaft 211. The connecting rod seat 31 is fixedly connected to the end plate 218 (or integrally formed with the end plate 218), and rotates with the rotation of the end plate 218, such that the driving connection rod 32 moves with the rotation of the connecting rod seat 31.

In some embodiments, the same plane in which the rotation axis of the connecting rod seat 31 and the axis of the rotation node of the second end 322 of the driving connection rod 32 are located can be designed to be parallel to the first axial direction F1; i.e., the rotation axis of the connecting rod seat 31 and the axis of the rotation node of the second end 322 of the driving connection rod 32 are distributed in sequence along the first axial direction F1, with one being directly in front of the other. Under such arrangement, when the power mechanism 20 drives the connecting rod seat 31 to rotate, the first end 321 of the driving connection rod 32 is offset from the first axial direction F1 by a smallest distance, and the driving force generated by the second end 322 of the driving connection rod 32 on the driven connection rod 33 has a larger component in the first axial direction F1, which increases the effective driving force of the driving connection rod 32 on the reciprocating motion of the driven connection rod 33. At the same time, the driving force generated by the second end 322 of the driving connection rod 32 on the driven connection rod 33 has a smaller component in the third axial direction F3, which reduces the squeezing force of the driven connection rod 33 on the swing rod mechanism 40, and therefore enhances the smoothness and stability of the movement of the driven connection rod 33. In addition, the connecting rod mechanism 30 requires less space in the third axial direction F3, which is more conducive to a compact type design of the housing 10.

It is understood that in some other embodiments, an angle (e.g., in the range of 0° to 45°, or in the range of 0° to 60° may be formed between the same plane in which the rotation axis of the connecting rod seat 31 and the axis of the rotation node of the second end 322 of the driving connection rod 32 are located and the X-axis.

Referring to FIGS. 1, 2, and 6, in some embodiments, the rotation node of the second end 322 of the driving connection rod 32 is located directly behind the driven connection rod 33 in the first axial direction F1 (herein, the end of the driven connection rod 33 away from the connecting rod seat 31 is used as the front end), such that the location of the force of the second end 322 on the driven connection rod 33 is directly behind the driven connection rod 33, resulting in a smaller force arm. The force required for the driving connection rod 32 to drive the driven connection rod 33 to reciprocate is thus smaller, which results in a smaller torque required for the power mechanism 20 to drive the connecting rod seat 31 to rotate. Such arrangement reduces the power demand on the power mechanism 20 and reduces the power consumption of the massager. In other embodiments, the rotation node of the second end 322 of the driving connection rod 32 may also be at a rear side (e.g., rear upper, rear lower, left rear, right rear, etc.) of the driven connection rod 33.

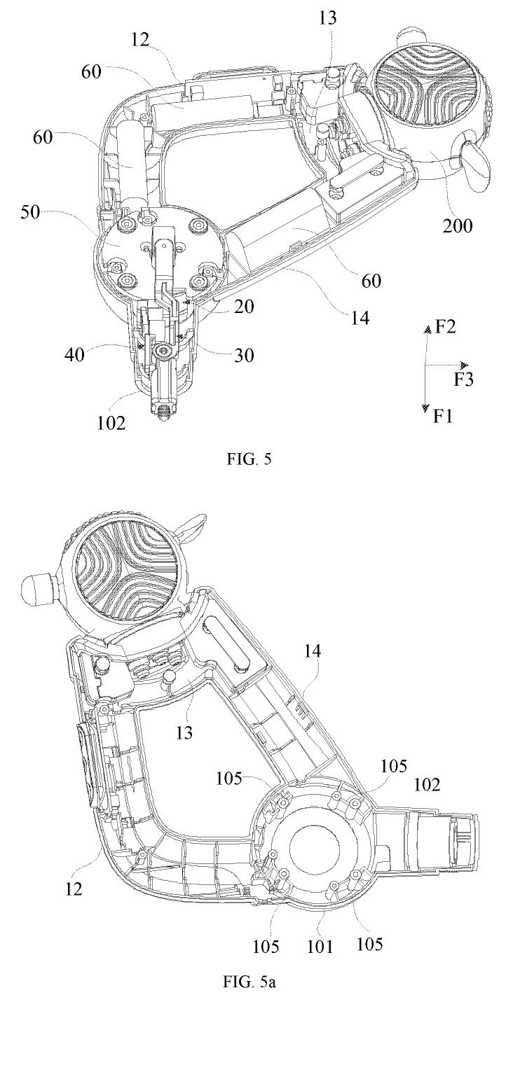

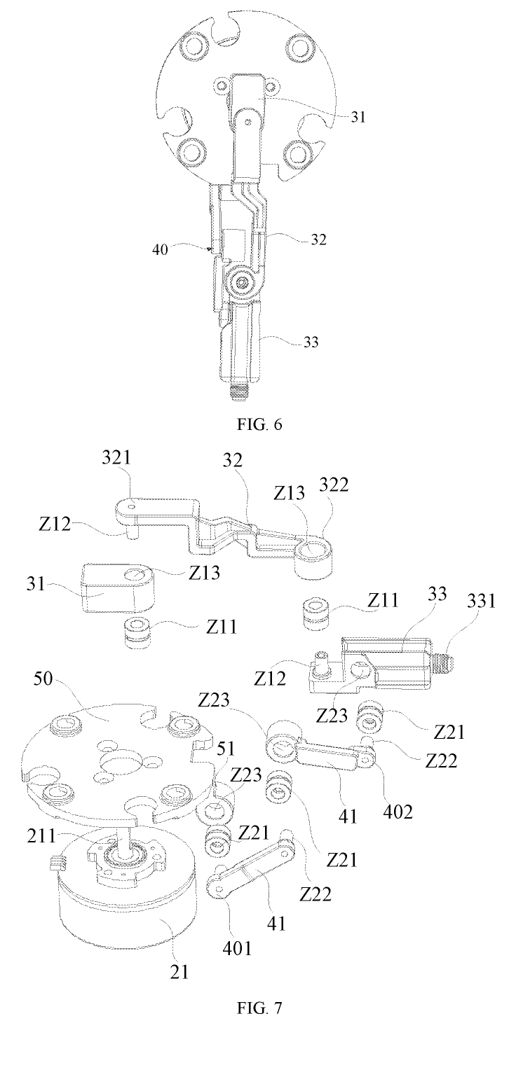

Referring to FIGS. 5 and 6, in some embodiments, the swing rod mechanism 40 may be arranged substantially parallel to the driving connection rod 32, i.e., the front end 401 of the swing rod mechanism 40 is close to the first end 321 of the driving connection rod 32, and the rear end 402 of the swing rod mechanism 40 is close to the second end 322 of the driving connection rod 32. In this way, the structure of the swing rod mechanism 40 and the structure of the connecting rod mechanism 30 are more centralized, allowing the structure of the driving device to be more compact. Thus, the space requirement of the driving device is smaller, which is conducive to reducing the external dimension of the massager and allows the overall appearance of the massager to be more compact and beautiful. It is understood that since there is no restriction on the rotatably-connected position between the front end 401 of the swing rod mechanism 40 and the bracket 50, the front end 401 may be located in various positions relative to the rear end 402, such as directly behind, directly in front, directly above, directly underneath, and obliquely behind, therefore the swing rod mechanism 40 may also be arranged in other ways in some other embodiments.

Referring to FIGS. 1 to 7, in some embodiments, the driving device may include one swing rod mechanism 40 and the swing rod mechanism 40 may include two rotatably-connected swing rods 41. When the driving device includes only one swing rod mechanism 40, the overall size of the driving device is smaller, the space occupied inside the massager is smaller, which is conducive to the compact structural design of the massager, and the cost of the driving device is correspondingly lower, which can reduce the cost of the massager. When the swing rod mechanism 40 of the driving device includes only two swing rods 41, the swing rod mechanism 40 has the smallest number of swing rods 41 between the rear end 402 and the front end 401, therefore having the shortest force arm. The rear end 402 is thus able to withstand a greater force in the third axial F3 acted thereon by the second end 322 of the driving connection rod 32 without deformation along the third axial direction F3, i.e., the swing rod mechanism 40 has the highest deformation resistance and is more stable and reliable. At the same time, the cost of the swing rod mechanism 40 is lower due to the small number of used swing rods 41. Therefore, the technical solution of the present embodiment can limit and stabilize the driven connection rod 33 with the most streamlined swing rod mechanism 40, which effectively reduces the cost and volume of the driving device, thereby reducing the cost of the massager using the driving device, and facilitates a miniaturized design of the massager.

In some embodiments, the driving device may include two swing rod mechanisms 40 substantially symmetrically arranged on both sides of the driven connection rod 33. In this way, by limiting and stabilizing the two sides of the driven connection rod 33 respectively by the two swing rod mechanisms 40, the stability of the reciprocating motion of the driven connection rod 33 can be better ensured. It is understood that in other embodiments, the two swing rod mechanisms 40 can be asymmetrically arranged, and more swing rod mechanisms 40 may be used.

Referring to FIGS. 1 to 3, or FIGS. 7 and 8, in some embodiments, the driven connection rod 33 includes a connecting table 332 arranged at an end of the driven connection rod 33 close to the connecting rod seat 31 and extending towards the connecting rod seat 31, and the second end 322 of the driving connection rod 32 is rotatably connected to the connecting table 332 to realize the rotational connection between the second end 322 and the driven connection rod 33. The connection table 332 can be extended from the bottom of the end of the driven connection rod 33 close to the connecting rod seat 31 to leave enough space above the connection table 332 located directly behind the driven connection rod 33 to accommodate the second end 322, such that the second end 322 is located directly behind the driven connection rod 33, the driven connection rod 33 is better driven, and the second end 322 shares the Y-axis space occupied by the driven connection rod 33. In this way, the Y-axis space requirement in the area where the driven connection rod 33 is located is reduced, which results in a more compact structure within an assembly chamber 101.

Continuing to refer to FIGS. 1 to 3, or FIGS. 7 and 8, in some embodiments, the driven connection rod 33 is provided with a step portion 333 on a side opposite to the rear end 402 of the swing rod mechanism 40, and the rear end 402 of the swing rod mechanism 40 is arranged at the step portion 333, and is rotatably connected to the driven connection rod 33. By providing the step portion 333 on the driven connection rod 33, it is convenient for the driven connection rod 33 to be rotatably connected to the rear end 402 of the swing rod mechanism 40. The step portion 333 may be a protrusion from the driven connection rod 33 or may be a recess in the driven connection rod 33.

The overall shape of the driven connection rod 33 may be shaped as a column (e.g., cylindrical column or square column), rod, etc. In the present embodiment, the driven connection rod 33 is shaped as a column arranged substantially along the first axial direction F1.

Referring to FIGS. 1 and 7, in some embodiments, the first end 321 of the driving connection rod 32 is rotatably connected to the connecting rod seat 31 through a first bearing structure, and the second end 322 of the driving connection rod 32 is also rotatably connected to the driven connection rod 33 through the first bearing structure; that is, each rotation node of the connecting rod mechanism 30 is connected through the first bearing structure (which has a low rotational resistance) to achieve rotational connection. In this way, the rotational resistance is smaller, the rotation is smoother, and there is almost no wear and loss at the rotation nodes of both ends of the driving connection rod 32, which further substantially extends the service life of the connecting rod mechanism 30. In some embodiments, the swing rods 41 of the swing rod mechanism 40 are rotatably connected to each other through a second bearing structure, the front end 401 of the swing rod mechanism 40 is rotatably connected to the bracket 10 through the second bearing structure, and the rear end 402 of the swing rod mechanism 40 is also rotatably connected to the driven connection rod 33 through the second bearing structure; that is, each rotation node of the swing rod mechanism 40 is connected through the second bearing structure (with low rotational resistance) to achieve rotational connection. In this way, the rotational resistance of each rotation node of the swing rod mechanism 40 is lower, the rotation is smoother, and there is almost no wear and tear at each rotation node of the swing rod mechanism 40, which further substantially extends the service life of the swing rod mechanism 40. In the case where each rotation node of the connecting rod mechanism 30 and each rotation node of the swing rod mechanism 40 are connected through a bearing structure to achieve rotational connection, the movements of the connecting rod mechanism 30 and the swing rod mechanism 40 are smoother, and the service life of the swing rod mechanism 40 is substantially extended, i.e., the smoothness of the driving device is improved and the service life of the driving device is extended. Therefore, the operation smoothness of the massager using the driving device is significantly improved and the service life of the massager using the driving device is significantly extended. Moreover, since each rotation node of the driving device is connected through a bearing structure to achieve rotational connection, even if the stroke of the driven connection rod (i.e., the maximum stroke of the reciprocating motion along the first axial direction F1) is significantly increased, there is almost no effect on the wear and tear of each rotation node, such that the massage head of the massager can have a larger stroke.

Referring to FIG. 7, the first bearing structure includes a first bearing Z11, a first bearing column Z12, and a first bearing hole Z13, all the axes of which are located along the second axial direction F2. The first bearing Z11 is arranged in the first bearing hole Z13 and an outer ring of the first bearing Z11 is fixed to the first bearing hole Z13. The first bearing column Z12 is inserted in an inner ring of the first bearing Z11 and fixed to the inner ring of the first bearing Z11. The first bearing column Z12 and the first bearing hole Z13 of the first bearing structure are arranged on the two parts that are rotatably connected through the first bearing structure, respectively. In this embodiment, the first bearing column Z12 is arranged on the first end 321 of the driving connection rod 32, the first bearing hole Z13 is defined in the connecting rod seat 31, the first bearing hole Z13 is defined in the second end 322 of the driving connection rod 32, and the first bearing column Z12 is arranged on the driven connection rod 33. In other embodiments, the positions of the first bearing column Z12 and the first bearing hole Z13 on the two rotatably-connected parts can be interchanged. For example, the first bearing hole Z13 is defined in the first end 321 of the driving connection rod 32, the first bearing column Z12 is arranged on the connecting rod seat 31, the first bearing column Z12 is arranged on the second end 322 of the driving connection rod 32, and the first bearing hole Z13 is defined in the driven connection rod 33.

Referring to FIG. 7, the second bearing structure includes a second bearing Z21, a second bearing column Z22, and a second bearing hole Z23,all the axes of which are located along the third axis F3. The second bearing Z21 is arranged in the second bearing hole Z23 and an outer ring of the second bearing Z21 is fixed to the second bearing hole Z23. The second bearing column Z22 is inserted into an inner ring of the second bearing Z21 and is fixed to the inner ring of the second bearing Z21. The second bearing column Z22 and the second bearing hole Z23 of the second bearing structure are arranged on the two parts rotatably connected through the second bearing structure, respectively. In this embodiment, the second bearing column Z22 is arranged on the front end 401 of the swing rod mechanism 40, the second bearing hole Z23 is defined in the bracket 50, the second bearing column Z22 is arranged on the rear end 402 of the swing rod mechanism 40, and the second bearing hole Z23 is defined in the driven connection rod 33. In other embodiments, the positions of the second bearing column Z22 and the second bearing hole Z23 on the two rotatably-connected parts can be interchanged. For example, the second bearing hole Z23 is defined in the front end 401 of the swing rod mechanism 40, the second bearing column Z22 is arranged on the bracket 50, the second bearing hole Z23 is defined in the rear end 402 of the swing rod mechanism 40, and the second bearing column Z22 is arranged on the driven connection rod 33.

Referring to FIG. 7a, which shows a sectional-cross view showing a first component 310 is rotatably connected to a second component 320 through a bearing structure in accordance with an embodiment, the above two parts that are rotatably connected through the first bearing structure, and/or, the two parts that are rotatably connected through the second bearing structure may be realized by using the embodiment shown in FIG. 7a. In this embodiment, the bearing column 330 includes a wider end 3301, a smooth segment 3302 close to the wider end 3301, and a threaded segment 3303 away from the wider end 3301. The first component 310 is provided with a locking screw hole 311 engaged with the threaded segment 3303. The second component 320 is provided with a bearing hole, a bearing 340 is arranged in the bearing hole, and an outer ring of the bearing 340 is fixed to the bearing hole. The bearing column 330 is inserted into an inner ring of the bearing 340, and the smooth segment 3302 is attached to the inner ring of the bearing 340. The threaded segment 3303 protrudes out of the inner ring of the bearing 340 and is threadedly connected to the locking screw hole 311 in the first component 310, such that the wider end 3301 of the bearing column 330 abuts an end of the inner ring of the bearing 340. Furthermore, an annular flange 3201 may be arranged on an inner wall of one end of the bearing hole of the second component 320 close to the locking screw hole 311. The outer ring of the bearing 340 abuts the annular flange 3201 under the locking of the bearing column 330. An annular protruding stage 312 is arranged on a periphery of the locking screw hole 311 of the first component 310, the annular protruding stage 312 abuts one end of the inner ring of the bearing 340closeto the locking screw hole 311, and the inner ring of the bearing 340 is clamped between the annular protruding stage 312 and the wider end 3301 of the bearing column 330, thereby allowing the rotational connection between the first component 310 and the second component 320 to be more stable and reliable. The first component 310 and the second component 320 may be the two parts that are rotatably connected through the first bearing structure as described above, or may be the two parts that are rotatably connected through the second bearing structure as described above.

It is to be noted that, in other embodiments, the rotational connection of each rotation node of the connecting rod mechanism 30, and the rotational connection of each rotation node of the swing rod mechanism 40, may also be realized by adopting other commonly-used rotational connection methods; for example, the two rotatably-connected parts are respectively provided with an axial rod and an axial hole, and the axial rod may be rotatably inserted in the axial hole.

Referring to FIGS. 1 to 3, and FIG. 7, in some embodiments, the power mechanism 20 includes a motor 21. The motor 21 is fixed to the bracket 50, an output shaft 211 of the motor 21 is arranged along the second axial direction F2, and the output shaft 211 of the motor 21 drives the connecting rod seat 31 to rotate directly or indirectly. In the drawings of this embodiment, the connecting rod seat 31 is fixed to the output shaft 211 of the motor 21, and the output shaft 211 directly drives the connecting rod seat 31 to rotate. The power mechanism 20 drives the connecting rod seat 31 to rotate in the following manner: the motor 21 of the power mechanism 20 is directly fixedly connected to the connecting rod seat 31 through the output shaft 211 thereof, such that the connecting rod seat 31 synchronously rotates with the output shaft 211. That is, in this embodiment, the motor 21 of the power mechanism 20 drives the connecting rod seat 31 in a direct-driving manner, which allows for the omission of mechanical transmission component, and simplifies the structural design and reduces the volume and occupied space. At the same time, the problems of reverse clearance, hysteresis, and elasticity brought about by the mechanical transmission can be avoided, thus having a higher degree of precision and reliability. Moreover, the energy loss, noise, and vibration brought about by the mechanical transmission can also be reduced, thereby improving energy utilization efficiency and allowing the operation to be quieter.

The connection between the connecting rod seat 31 and the output shaft 211 of the motor 21 can be as follows: one side of a peripheral wall of the output shaft 211 has a positioning plane, the connecting rod seat 31 is provided with a shaft hole that is adapted to the output shaft 211, the output shaft 211 is inserted in the shaft hole, and the connecting rod seat 31 is provided with at least one screw hole that is perpendicular to the shaft hole and communicates with the shaft hole, and the screw hole engages with a lock screw, and an end of the lock screw abuts the positioning plane of the output shaft 211, such that the output shaft 211 is fixed to the connecting rod seat 31. In other embodiments, the connection between the connecting rod seat 31 and the output shaft 211 of the motor 21 may be realized through other ways. For example, the connecting rod seat 31 is clamped and fixed to the output shaft 211, or the connecting rod seat 31 is bonded or welded to the output shaft 211, and so on. The connecting rod seat 31 may be shaped as a rod, a block, a column, etc., and in this embodiment, the connecting rod seat 31 is shaped as an elongated block.

It is understood that in other embodiments, the connecting rod seat 31 may also be driven by the output shaft 211 of the motor 21 in an indirect-driving manner, such as the output shaft 211 of the motor 21 is connected to the connecting rod seat 31 through a mechanical transmission component (e.g., a gearbox, a synchronous belt, a mixing wheel, or a silk rod, etc.).

Referring to FIGS. 1 to 3, and FIG. 7, in some embodiments, the first end 321 of the driving connection rod 32 is rotatably connected to the side of the connecting rod seat 31 away from the motor 21, such that when the first end 322 of the driving connection rod 32 rotates around the rotation axis of the connecting rod seat 31 (herein, also the output shaft 211 of the motor 21), the output shaft 211 of the motor 21 does not interfere with the driving connection rod 32, and therefore the first end 321 of the connecting rod 32 can rotate in a full circle.

Referring to FIGS. 1 to 3, 5 and 7, in this embodiment, the motor 21 is fixed to one side of the bracket 50 and the connecting rod seat 31 is located on an opposite side of the bracket 50, and the output shaft 211 of the motor 21 extends through the bracket 50 to be fixed to the connecting rod seat 31. In some other embodiments, the motor 21 may also be arranged on the same side of the bracket 50 as the connecting rod seat 31, and the output shaft 211 of the motor 21 may not need to extend through the bracket 50.

The motor 21 may be connected to the bracket 50 in a variety of ways. For example, the motor 21 is connected to the bracket 50 by a plurality of screws, or the bracket 50 is provided with a clip structure engageable with the motor 21 such that the motor 21 is clamped to the bracket 50, or the motor 21 is attached to the bracket 50, and so on.

Referring to FIGS. 1 to 3 and FIG. 7, in some embodiments, a base 51 is arranged on the bracket 50, and the front end 401 of the swing rod mechanism 40 is rotatably connected to the base 51. With the base 51, the bracket 50 is rotatably connected to the front end 401 of the swing rod mechanism 40 conveniently. The base 51 may be an integrated part of the bracket 50 or may be an independent component mounted to the bracket 50. In the present embodiment, the base 51 and the motor 21 are located on the same side of the bracket 50, and the base 51 and the connecting rod seat 31 are located on different sides of the bracket 50. In this way, the position of the front end 401 of the swing rod mechanism 40 may not interfere with the rotation of the connecting rod seat 31 and the swinging of the first end 321 of the driving connection rod 32, allowing the structure of the driving device to be more compact.

Referring to FIGS. 4 and 5, the massager of an embodiment of the present disclosure includes a housing 10 and the driving device is arranged in the housing 10. The specific structure of the driving device can refer to the aforementioned examples, and will not be repeated here. The massager of the present disclosure, by adopting all the technical solutions of the aforementioned driving device examples, has at least all the beneficial effects brought by the technical solutions of the aforementioned embodiments, and will not be repeated one by one here.

The bracket 50 of the driving device is fixed to the housing 10; the bracket 50 and the housing 10 can be two separated parts and the bracket 50 is fixedly connected to the housing 10 through a fixing structure (e.g., a snap structure, a screw, etc.). The bracket 50 and the housing 10 can be integrally formed, that is, the bracket 50 is a part of the housing 10. In this case, the front end 401 of the swing rod mechanism 40 is rotatably connected to the housing 10 in a direct way. In the drawings of the embodiment of the present disclosure, the bracket 50 and the housing 10 are two separated parts.

Referring to FIG. 5 and FIG. 5a, in some embodiments, the fixing method between the bracket 50 and the housing 10 may be as follows: a plurality of support portions 105 are arranged on the housing 10, and the bracket 50 is arranged the support portions 105 and are locked with each of the support portions 105 by screws. In other embodiments, other fixing methods may be adapted to fix the bracket 50 to the housing 10. The structure of the bracket 50 is not specially limited and can be designed according to actual needs; in the drawings of the embodiment of the present disclosure, the bracket 50 is substantially plate-like.

An opening 102 is formed in one end of the housing 10 close to the driven connection rod 33, allowing the massage head to be connected to the driven connection rod 33. In an embodiment, one end of the driven connection rod 33 away from the connecting rod seat 31 protrudes out of the housing 10 from the opening 102 to be connected to the massage head; in another embodiment, the driven connection rod 33 is located entirely within the housing 10 while the massage head extends into the housing 10 from the opening 102 to be connected to the driven connection rod 33. In the embodiment, one end of the driven connection rod 33 protrudes out of the housing 10 from the opening 102, and is detachably connected to the massage head, which facilitates the assembly and disassembly of the massage head and thus allows users to quickly change different massage heads to satisfy different massage needs. The detachable connection between the driven connection rod 33 and the massage head can be referred to as described in the foregoing embodiment of the driving device, and will not be repeated herein.

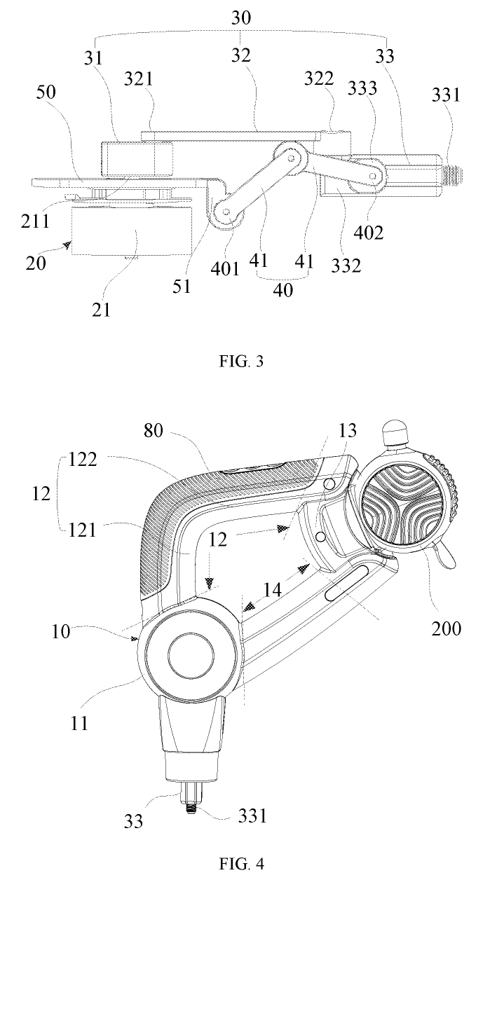

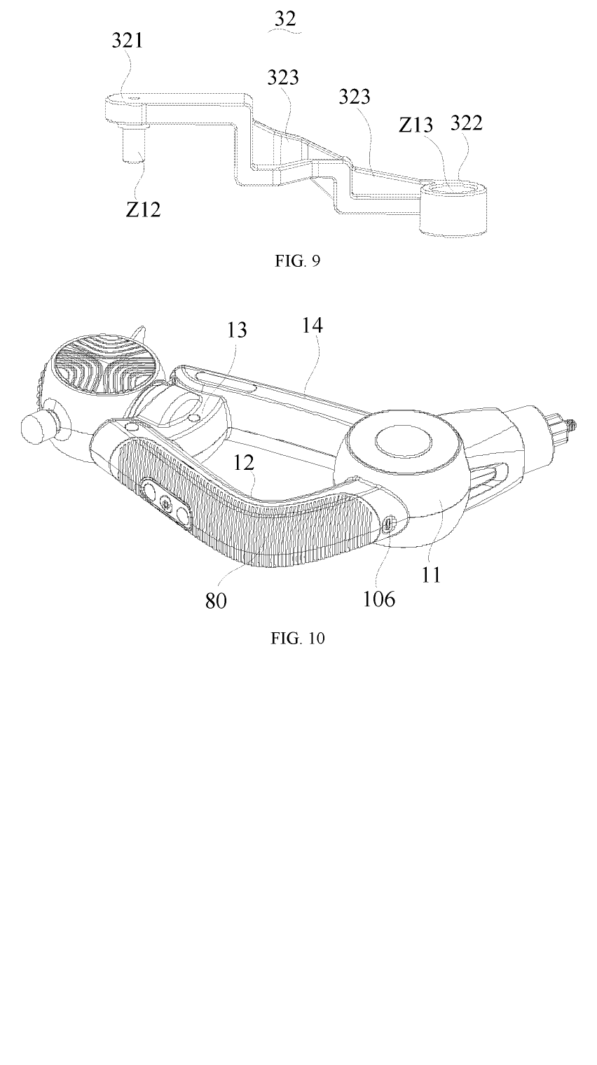

The structure of the driving connection rod 32 is not specifically limited, and may be designed according to the space and structural situation within the housing 10 of the massager. For example, the driving connection rod 32 may be shaped as a straight strip (with reference to FIG. 3), or a bent structure with multiple bent sections (with reference to FIGS. 1 and 2). Referring to FIGS. 1, 7, and 9, when the driving connection rod 32 is shaped as a bent structure with multiple bent sections, reinforcement bars 323 may be arranged on each bent section to enhance the rigid strength of the driving connection rod 32, avoiding deformation at the bent sections due to the elasticity of the material, ensuring stable transmission of the driving connection rod 32.

In some embodiments, the housing 10 includes a first assembly portion 11 and a handheld portion 12 connected to the first assembly portion 11 for users to grip the massager. The driving device is arranged on the first assembly portion 11, and the opening 102 of the housing 10 is formed in the first assembly portion 11.

As shown in FIGS. 11 and 11a, in some embodiments, the first assembly portion 11 is arranged at one end of the handheld portion 12, and the housing 10 as a whole may be substantially shaped as a T (referring to FIG. 11) or a cross(referring to FIG. 11a), i.e., the first assembly portion 11 is connected to the handheld portion 12 to form a T-shaped or cross-shaped structure. The housing 10 of the massager has a structure having an overall shape like a T or a cross, such that the overall shape of the massager is more beautiful, and meanwhile, it is also more convenient for users to hold the massager. In other embodiments, the housing 10 may also be of other shapes.

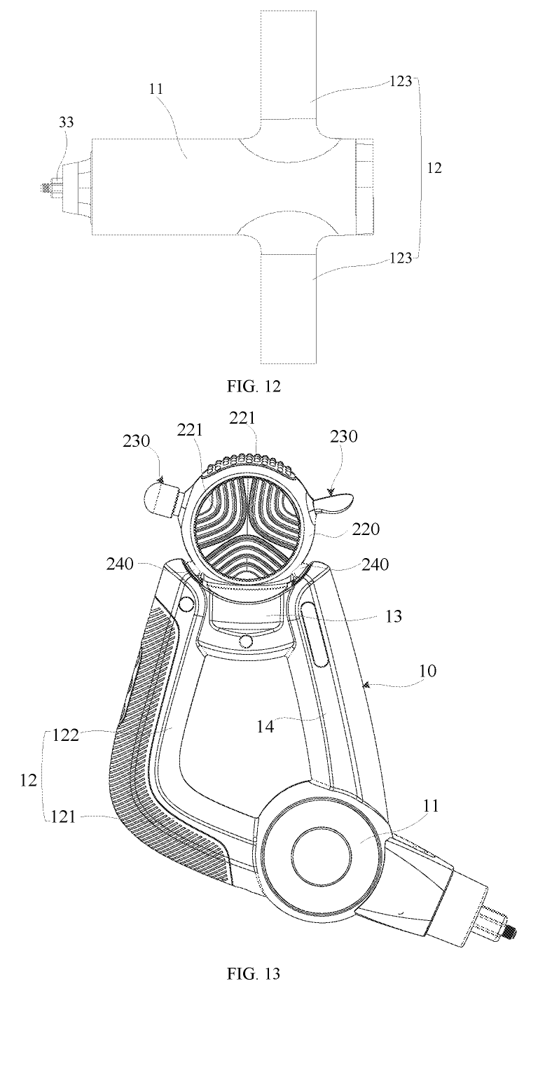

As shown in FIG. 12, in some embodiments, the handheld portion 12 includes two handles 123 substantially symmetrically arranged on both sides of the first assembly portion 11, such that the handheld portion 12 and the first assembly portion 11 form the housing 10 having an overall shape like a T or a cross, and users can hold the two handles 123 of the handheld portion 12 with two hands, which gives users an option of holding with both hands.

In some embodiments, an additional massaging mechanism may be arranged on an end of the first assembly portion 11 away from the opening 102. The additional massaging mechanism may be detachably connected to the first assembly portion 11 or may be fixed to the first assembly portion 11. The additional massaging mechanism may have the same massage function as that of the first assembly portion 11, or may have a different massage function from that of the first assembly portion 11 (for example, the additional massaging mechanism may provide a vibration massage, a weak electric stimulation massage, or a hot massage, etc.). By providing the driving device and the additional massaging mechanism at each end of the first assembly portion 11, the massager can provide massage not only by driving the massage head to perform reciprocating motion through the driven connection rod 33, but also provide massage by the additional massaging mechanism, thereby allowing the massage mode of the massager to be more diversified, and to enrich users' experience of using the massager.

Referring again to FIGS. 4, 5, and 10, in some embodiments, the housing 10 includes the first assembly portion 11, the handheld portion 12, and a second assembly portion 13 for assembling the additional massaging mechanism 200. The first assembly portion 11 and the second assembly portion 13 are connected to two ends of the handheld portion 12respectively, the driving device is arranged inside the first assembly portion 11, and the opening 102 of the housing 10 is formed in the first assembly portion 11. The second assembly portion 13 is used for assembling the additional massaging mechanism 200, and the additional massaging mechanism 200 may be detachably connected to the second assembly portion 13 or may be directly fixed to the second assembly portion 13. The additional massaging mechanism 200 may have the same massage function as that of the first assembly portion 11, or may have a different massage function from that of the first assembly portion 11 (for example, the additional massaging mechanism may provide a vibration massage, a weak electric stimulation massage, or a hot massage, etc.). The technical solution of the massager of the present embodiment has the housing 10 including the first assembly portion 11 and the second assembly portion 13 respectively connected to the two ends of the handheld portion 12, the driving device is arranged in the first assembly portion 11, and the opening 102 is formed in the first assembly portion 11, such that the retractable massage function of the massager is realized; moreover, a new massage function is realized by the additional massaging mechanism 200 in the second assembly portion 12. In this way, the massage mode of the massager is more diversified, enriching users' experience.

Referring to FIGS. 13 to 16, in some embodiments, the additional massaging mechanism 200 includes a vibration device 210, a shell 220, and at least one massage portion 230. The vibration device 210 is fixedly connected to the housing 10either directly or indirectly through an intermediate structure. In the present embodiment, the additional massaging mechanism 200 includes two massage portions 230; it is understood that in some other embodiments, the number of the massage portion 230 may be one, three, four or more. The two massage portions 230 may have the same shape or different shapes; for example, the two massage portions 230 have different shapes to produce different massage feelings or to massage different body parts of the user. A part of one massage portion 230 extending out of the shell 220 has a substantially cylindrical structure, while a part of the other massage portion 230 extending out of the shell 220 has a substantially arc-shaped flaky structure. In other embodiments, the part of the massage portion 230extending out of the shell 220 can also have other shapes (such as spherical, dome-shaped, etc.).

The shell 220 is wrapped around the vibration device 200 to enclose the vibration device 210, which prevents the internal structure from directly contacting users, and also achieves dustproof and waterproofing of the vibration device 210, and therefore the vibration device 210 is protected. The assembly of the shell 220 may be as follows: the shell 220 is fixedly connected to the vibration device 210, or the shell 220 is fixedly connected to the housing 10. The shape of the shell 220 is not specially limited, and may be spherical, cylindrical, square columnar, trigonal columnar, drum-shaped, and other shapes. Each massage portion 230 is fixedly attached to the vibration device 210, and one end of the massage portion 230 away from the vibration device 210 extends out of the shell 220. That is, at least one aperture 224 (refer to FIG. 16) is formed in the shell 220 and respectively corresponds to the massage portion 230, and each massage portion 230 is inserted into the corresponding aperture 224. The end of the massage portion 230 that extends out of the shell 220 is used for contacting users to perform a massage.

In this embodiment, the massage portion 230is directly connected to the vibration device 210, and the end of the massage portion 230 away from the vibration device 210 passes through the shell 220 to protrude to the outside of the shell 220 for contacting users. When users use the massager, the vibration device 210 works to generate vibration, and the vibration device 210 directly drives the massage portion 230 to vibrate, such that the end of the massage portion 230 extending out of the shell 220 vibrates and massages the users. Since the massage portion 230 is directly driven by the vibration device 210 to vibrate, the vibration of the massage portion 230 does not pass through the shell 220 for transmission, which avoids the attenuation of the vibration energy by the shell 220. In this way, the vibration conversion efficiency of the massager and the vibration intensity of the massage portion 230 are both improved.

In some embodiments, in order to allow users to enjoy more massage of the massage portion 230 of different shapes or sizes, and to enrich the massage experience, the massage portion 230 may include a fixing section 231 and a massage section 232. The fixing section 231 is fixedly connected to the vibration device 210, and the massage section 232 is detachably connected to one end of the fixing section 231 away from the vibration device 210. Since the actual vibration effect of the massage portion 230comes from the part protruding out of the shell 220 (that is the massage section 232), and the massage section 232 is detachably connected to the fixing section 231, such that when users want to experience the vibration of different shapes or sizes, users can replace the massage section 232 of other shapes or sizes. In this way, when users want to experience massage with a massage portion 230 of a different shape or size, users can conveniently remove the current massage section 232 from the massage portion 230 and install a new massage section 232 onto the fixing section 231.

The detachable connection between the massage section 232 and the fixing section 231 may be a threaded connection. For example, the fixing section 231 and the massage section 232 are respectively provided with screw holes and studs that are adapted to each other. The detachable connection between the massage section 232 and the fixing section 231can also be a plugging connection. For example, the fixing section 231 and the massage section 232 are respectively provided with plug holes and inserting portions that are adapted to each other. In other embodiments, the massage section 232 and the fixing section 231 may also adopt other detachable connecting methods.

In some embodiments, one end of the fixing section 231 away from the vibration device 210 (i.e., the end connected to the massage section 232) is inserted into the aperture 224 of the shell 220. The end of the fixing section 231 connected to the massage section 232 is exposed to the surface of the shell 220, such that the disassembly and assembly of the massage section 232 with the fixing section 231 is more convenient. In some embodiments, the end of the fixing section 231 away from the vibration device 210 may protrude out of the shell 220, i.e., extend to the outer side of the shell 220, which facilitates the disassembly and assembly of the massage section 232. In other embodiments, the end of the fixing section 231 away from the vibration device 210 may be at a distance from the aperture 224 of the shell 220, that is, one end of the massage section 232 is inserted into the shell 220 to be connected to the fixing section 231.

In some other embodiments, the massage portion 230 may have an integral structure and the massage portion 230 is detachably connected to the vibration device 210, which satisfies users' need to replace the massage head with a different shape or size. For example, the massage portion 230 is screwed to the vibration device 210. When the massage portion 230 needs to be replaced, the massage portion 230 can be detached from the vibration device 210 by screwing and withdrawn from the aperture 224 of the shell 220. Then the new massage portion 230 can be assembled in the reverse process. In other embodiments, the massage portion 230 and the vibration device 210 may also be connected by other detachable means.

In some embodiments, the shell 220 is fixedly connected to the vibration device 210, and the shell 220 vibrates synchronously with the vibration device 210. In this way, the situation in which the massage portion 230 vibrates alone and collides with the shell 220 to generate noise can be avoided, such that the massager works with less noise. Furthermore, the shell 220 vibrates synchronously with the vibration device 210, which allows the outer surface of the shell 220 to be used as a vibration massage surface and thus increases the massage mode of the massager. The shell 220 can be fixed to the vibration device 210 by a plurality of screws or a snap structure, etc.

Referring to FIGS. 13 to 16, in some embodiments, the outer wall of the shell 220 is provided with at least one rub piece 221. When the massager is in operation, the shell 220 vibrates with the vibration device 210, while the rub piece 221 vibrates with the shell 220. When the rub piece 221 contacts the body part of the user, a vibration massage through the rub piece 221 is carried out. The rub piece 221 vibrates with the skin of the user to realize a heat massage through high-frequency vibration. In some embodiments, a side of the rub piece 221 contacting users (i.e., the side of the massage portion 230 back to the shell 220) can have an uneven surface, for example, uniformly-distributed bumps or convex bars may be arranged on the side of the rub piece 221 contacting users. In other embodiments, the side of the rub piece 221 contacting users can also have a smooth surface. The number of the rub piece 221 arranged on the shell 220 may be one or more. In some embodiments, the rub piece 221 can be arranged in a corresponding mounting slot 222 formed in an outer wall of the shell 220.

Referring to FIGS. 4, 13, and 14, when the second assembly portion 13 and the shell 220 are located too close together, the shell 220 may collide with the second assembly portion 13 when the shell 220 vibrates, which may generate noise and cause damage to the shell 220 or the second assembly portion 13. The shell 220 may transmit a stronger vibration to the second assembly portion 13 as well. Considering this, the present embodiment adopts at least one flexible vibration-damping member 240 arranged between the shell 220 and the end of the second assembly portion 13 close to the shell 220. The flexible vibration-damping member 240 resiliently abuts the second assembly portion 13 and the shell 220 to support, buffer, and dampen vibrations for the shell 220. In this case, when the shell 220 vibrates with the vibration device 210, the shell 220 does not directly collide with the second assembly portion 13. Such arrangement protects the shell 220 from rigid collision, reduces noise, and reduces the vibration sensation of the housing 10. In this embodiment, the massager is provided with two flexible vibration-damping members 240, and the two flexible vibration-damping members 240 are substantially symmetrically arranged on both sides of the shell 220. It is understood that the number of the flexible vibration-damping member 240 in other embodiments can be one or more than two. The flexible vibration-damping member 240 can include any kind of rubber block made of soft rubber material with elasticity, or an elastic airbag, and so on.

In some embodiments, the weight of the various parts of the shell 220 may be correspondingly designed according to the specific arrangement of the massage portion 230. A counterweight block 223 can also be additionally arranged at some positions of the shell 220, such that the vibration of the shell 220 in various directions is equalized and the vibration of the shell 220 is more stable.

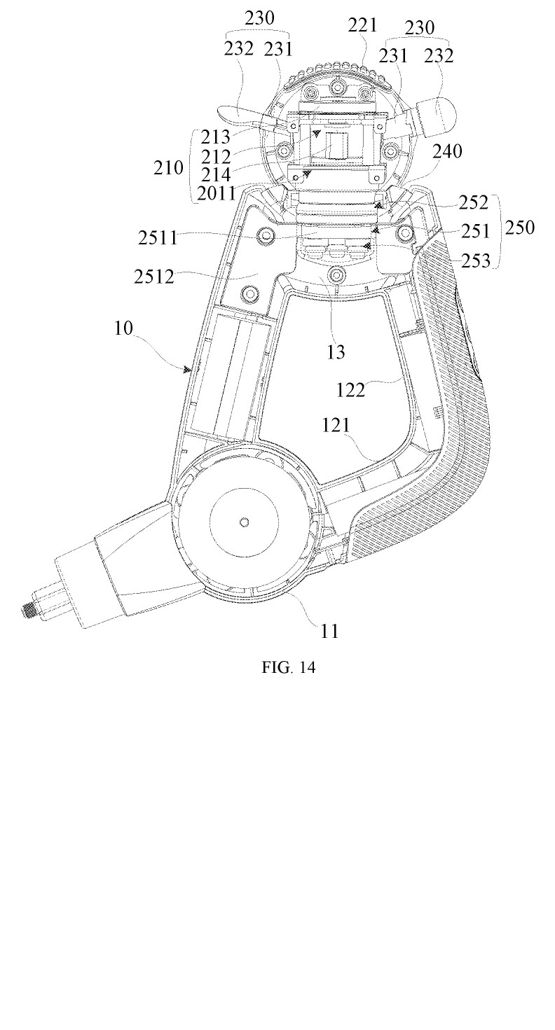

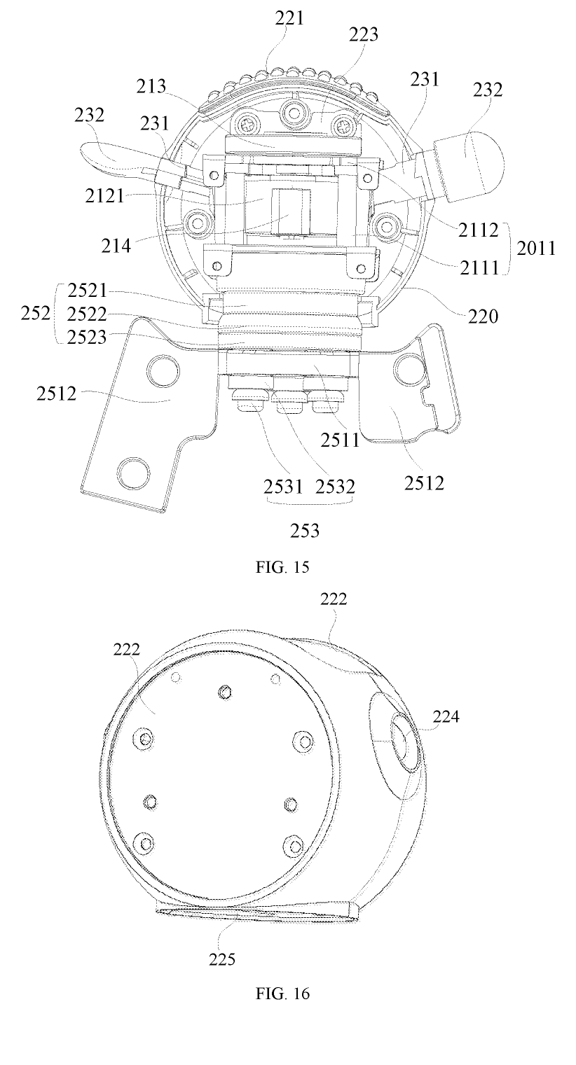

Referring to FIGS. 14 and 15, in some embodiments, the vibration device 210 includes a mounting frame 2011, a first motor 212, an eccentric member 213, and a balancing member 214. The mounting frame 2011 is fixed to the second assembly portion 13. The mounting frame 2011 can be directly connected to the second assembly portion 13 or indirectly connected to the second assembly portion 13 through an intermediate structure (e.g., the mounting frame 2011 is fixedly connected to the second assembly portion 13 through a buffer mechanism). The first motor 212 is arranged on the mounting frame 2011. The eccentric member 213 is fixed to one end of the output shaft of the first motor 212, and the balancing member 214 is connected to the other end of the output shaft or to a rotor 2121 of the first motor 212. The eccentric member 213 and the balancing member 214 follow the rotation of the output shaft of the first motor 212, i.e., the eccentric member 213 and the balancing member 214 perform an eccentric movement, whereby the centrifugal force of the eccentric member 213 and the balancing member 214 drives the mounting frame 2011 to vibrate.

In some embodiments, in order to better balance the two ends of the output shaft of the first motor 212 during rotation, thereby avoiding the first motor 212 from being biased and enhancing the frequency and/or amplitude of the vibration of the vibration device 210, the balancing member 214 and the eccentric member 213 can be located in the same orientation relative to the output shaft, that is, the balancing member 214 and the eccentric member 213 are in an up-and-down relative positional relationship along the axial direction of the output shaft.

In some embodiments, the mounting frame 2011 may include a mounting seat 2111 and a mounting plate 2112 fixedly connected to the mounting seat 2111, and the mounting plate 2112 and the mounting seat 2111 are enclosed to form a receiving space. The first motor 212 is in the receiving space and fixed to one side of the mounting plate 2112 facing the receiving space. The massage portion 230 is fixedly connected to the mounting seat 2111 or the mounting plate 2112 (FIG. 15 takes the massage portion 230 being fixedly connected to the mounting seat 2111 as an example). The output shaft of the first motor 212 can also be arranged without passing through the mounting plate 2111, i.e., the eccentric member 213 and the balancing member 214 are both arranged within the receiving space. The first motor 212, by driving the output shaft to rotate, causes the eccentric member 213 and the balancing member 214 to perform an eccentric movement to generate a centrifugal force, which in turn causes the first motor 212 to generate a vibration. The vibration of the first motor 212 is transmitted to the mounting frame 2011, causing the mounting frame 2011 to vibrate with the massage portion 230.

The shapes of the mounting seat 2111 and the mounting plate 2112 are not specifically limited, and in the present embodiment, the mounting seat 2111 is substantially shaped as a cylinder, and the mounting plate 2112 is substantially shaped as a flat plate covering on an open end of the mounting seat 2111. It is understood that in other embodiments, the mounting seat 2111 and the mounting plate 2112 may have other shapes.

In some embodiments, the massage portion 230 (or the fixing section 231 of the massage portion 230) and the mounting seat 2111 or the mounting plate 2112 are integrally formed, such that the vibration device 210 transmits vibration to the massage portion 230 through the mounting frame 2011 more efficiently. Meanwhile, less vibration is lost, which can further improve the vibration intensity of the massage portion 230, allowing the massage vibration to be more powerful. It is understood that in other embodiments, the massage portion 230 (or the fixing section 231 of the massage portion 230) may be separated from the mounting seat 2111 or the mounting plate 2112.

With reference to FIGS. 14 to 16, in some embodiments, the additional massaging mechanism 200 further includes a vibration damping mechanism 250. An avoidance opening 225 is formed in one side of the shell 220 facing the housing 10, the vibration damping mechanism 250 is arranged in the avoidance opening 225, and the vibration device 210 is fixedly connected to the second assembly portion 13 of the housing 10 via the vibration damping mechanism 250. In this embodiment, the vibration device 210 and the housing 10 are indirectly connected through the vibration damping mechanism 250, which greatly reduces the intensity of vibration transmitted from the vibration device 210 to the housing 10. Therefore, the vibration that users feel from the housing 10 is very weak, resulting in minimal hand vibration, providing a more comfortable usage of the massager, and improving the user experience with the massager.

In some embodiments, the vibration damping mechanism 250 includes a fixing seat 251, a buffering assembly 252, and a fastening assembly 253. The fixing seat 251 is fixedly connected to the second assembly portion 13 of the housing 10. One end of the buffering assembly 252 resiliently abuts the vibration device 210, and the other end of the buffering assembly 252 resiliently abuts the fixing seat 251. The fastening assembly 253 is connected to the fixing seat 251 and the vibration device 210 to clamp the buffering assembly 252 between the fixing seat 251 and the vibration device 210. The buffering assembly 252 is always maintained at a state where the two ends of the buffering assembly 252 resiliently abut the fixing seat 251 and the vibration device 210 respectively. The vibration generated by the vibration device 210 is attenuated by the buffering assembly 252 and then transmitted to the fixing seat 251 through the buffering assembly 252, as well as transmitted to the fixing seat 251 through the fastening assembly 253, and then is transmitted to the housing 10 through the fixing seat 251. The fixing seat 251 attenuates the intensity of the transmitted vibration to a certain extent, such that the intensity of the vibration reaching the housing 10 is weaker, which facilitates realizing the vibration-free sensation of the housing 10.

In some embodiments, the fixing seat 251 includes an abutting portion 2511 and a fixing portion 2512 fixedly connected to the abutting portion 2511. The fixing portion 2512 is fixedly connected to the housing 10, and the buffering assembly 252 resiliently abuts the abutting portion 2511. The relatively weak vibration transmitted by the vibration device 210 through the buffering assembly 252 reaches the abutting portion 2511 of the fixing seat 251 at first, and then is transmitted from the abutting portion 2511 to the fixing portion 2512, thus, the intensity of the vibration is further attenuated. The vibration is finally transmitted to the housing 10 by the fixing portion 2512, such that the intensity of the vibration that actually reaches the housing 10 is even more minimal, which facilitates realizing a vibration-free sensation of the housing 10.

In some embodiments, the overall weight of the fixing seat 251can be designed to be greater than that of the buffering assembly 252, such that when the vibration transmitted from the buffering assembly 252 is transmitted to the fixing seat 251, an amplitude of the vibration generated by the fixing seat 251 is smaller. Thus, the vibration sensation transmitted by the fixing seat 251 to the housing 10 is relatively small. In some embodiments, the weight of the fixing portion 2512 may also be designed to be greater than that of the abutting portion 2511, such that when the vibration transmitted from the abutting portion 2511 reaches the fixing portion 2512, which has a greater weight than the abutting portion 2511, the amplitude of the vibration generated by the fixing portion 2512 is further reduced. This in turn results in a smaller vibration sensation transmitted by the fixing portion 2512 to the housing 10. In this embodiment, the fixing seat 251 includes two fixing portions 2512 and the two fixing portions 2512 are arranged on both sides of the abutting portion 2511 respectively, such that the vibration transmitted to the abutting portion 2511 is transmitted to the fixing portions 2512 on both sides respectively, and the amplitude of the vibration generated by the fixing portion 2512 is smaller, allowing the vibration sensation of the housing 10 to be relatively small.

Referring to FIG. 15, in some embodiments, the buffering assembly 252 includes a first buffering member 2521, a clapboard 2522, and a second buffering member 2523 sequentially stacked in a direction from the vibration device 210 to fixing seat 251. A side of the first buffering member 2521 away from the clapboard 2522resiliently abuts the vibration device 210, and a side of the second buffering member 2523 away from the clapboard 2522resiliently abuts the fixing seat 251. In this embodiment, the vibration generated by the vibration device 210 is first transmitted to the clapboard 2522 through the first buffering member 2521. Under the buffering effect of the first buffering member 2521, the vibration transmitted to the clapboard 2522 is partially attenuated. The clapboard 2522 then transmits the vibration to the fixing seat 251 through the second buffering member 2523. Under the buffering effect of the second buffering member 2523, the vibration transmitted to the fixing seat 251 is attenuated again. And finally the vibration is transmitted to the housing 10 through the fixing seat 251 which can also attenuate part of the vibration. Under such arrangement, the vibration intensity that finally reaches the housing 10 is very weak, and thus the vibration generated by the housing 10 is very small. Users basically can not feel obvious vibration. The first buffering member 2521 and the second buffering member 2523 can be made of an elastic material, and the first buffering member 2521 and the second buffering member 2523 can be plate-shaped to be better attached to the clapboard 2522 and achieve a better buffering and vibration damping effect.

In other embodiments, the buffering assembly 252 can also include a greater number of buffering members and clapboards 2522, for example, the buffering assembly 252 includes three buffering members and two clapboards 2522, four buffering members and three clapboards 2522, and the buffering members and the clapboards 2522 are alter natively arranged.

In some embodiments, the fastening assembly 253 includes at least one strip connector 2531 and a buffer column 2532 respectively corresponding to the strip connector 2531. One end of the buffer column 2532 passes through the fixing seat 251 and is inserted in the buffering assembly 252, while the other end of the buffer column 2532 is clamped to the side of the fixing seat 251away from the buffering assembly 252. One end of the strip connector 2531 passes through the buffer column 2532, the fixing seat 251, and the buffering assembly 252 in turn and is fixedly connected to the vibration device 210, and the other end of the strip connector 2531 is clamped to a surface of the other end of the buffer column 2532. Since the buffer column 2532 is arranged between the strip connector 2531 and the fixing seat 251, when the vibration device 210 transmits the vibration to the fixing seat 251 through the fastening assembly 253, the vibration is first transmitted to the strip connector 2531, the strip connector 2531 then transmits the vibration to the buffer column 2532, and finally, the buffer column 2532 transmits the vibration to the fixing seat 251. The vibration transmitted from the strip connector 2531 is attenuated by the buffer column 2532, such that the vibration transmitted from the vibration device 210 to the fixing seat 251 through the fastening assembly 253 is also small, and thus the vibration of the housing 10 is small.

The strip connector 2531 may be an elongated screw, a rod portion of the elongated screw passes through the buffer column 2532, the fixing seat 251 and the buffering assembly 252 to be screwed and secured to the vibration device 210. A wider end of the screw (i.e., the other end of the strip connector 2531) is snapped onto the surface of the other end of the buffer column 2532, such that the other end of the buffer column 2532 is clamped between the wider end of the screw and the fixing seat 251. It is understood that in other embodiments, the strip connector 2531 can also be a pin or another structural member that is plugged and secured to the vibration device 210.

In some embodiments, the shell 220 can be fixedly connected to the housing 10, and the shell 220 is not connected to the vibration device 210. The inner wall of the shell 220 is spaced apart from the vibration device 210 by a distance greater than the vibration amplitude of the vibration device 210, i.e., the shell 220 does not follow the vibration of the vibration device 210 and the vibration of the vibration device 210 does not collide with the inner wall of the shell 220. The shell 220 is provided with the apertures 224 respectively corresponding to the massage portions 230, and each massage portion 230passes through the respective corresponding aperture 224. There is a gap between the inner wall of the aperture 224 and the corresponding peripheral wall of the massage portion 230, and the gap is greater than the vibration amplitude of the massage portion 230, such that the massage portion 230does not collide with the shell 220 even when the massage portion 230 vibrates. In this way, the vibration device 210 does not drive the shell 220 to vibrate, but only drives the massage portion 230 to vibrate. Compared to the solution in which the vibration device 210 drives the shell 220 to vibrate, in the solution of this embodiment, the vibration device 210 requires less power to realize the same vibration intensity of the massage portion 230.

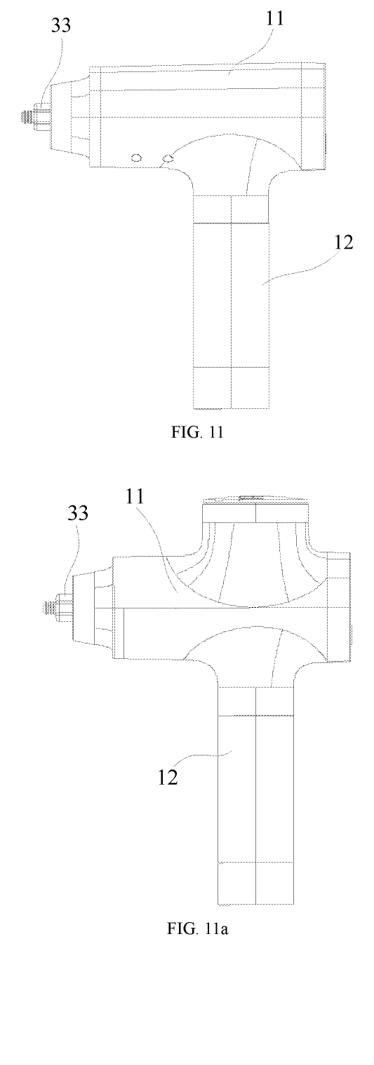

Referring to FIG. 10, in some embodiments, the handheld portion 12 is provided with an anti-slip sleeve 80. The anti-slip sleeve 80 is wrapped around the handheld portion 12 to provide a more stable grip for the user. The anti-slip sleeve 80 can be made of material that can improve the grip feeling for the user. In an embodiment, a recess may be formed in an outer wall of the handheld portion 12 that is suitable for the shape and size of the anti-slip sleeve 80, and the anti-slip sleeve 80 is embedded in the recess. The anti-slip sleeve 80 can be connected to the recess in the handheld portion 12 by a snap structure, for example, several insertion holes are formed in a bottom of the recess, several snap buttons are arranged on a side of the anti-slip sleeve 80 facing the recess, and the snap buttons are respectively plugged in the insertion holes.

In some embodiments, the massager can be provided with buttons for adjusting a mode of the massager, adjusting a gear of the massager, or controlling the massager to be turned on and off, etc.

Referring to FIG. 4, 5, or 13, in some embodiments, the handheld portion 12 includes a first handheld section 121 and a second handheld section 122 that are connected and distributed in a roughly L-shaped manner; in the present embodiment, the first handheld section 121 is substantially perpendicular (e.g., a 90°±10° angle) to the second handheld section 122. It is understood that in other embodiments, the angle between the first handheld section 121 and the second handheld section 122 may be changed, such as 70°, 75°, 105°, 110°, 115°, etc. The first handheld section 121 is connected to the first assembly portion 11, and the second handheld section 122 is connected to the second assembly portion 13. In this way, when users use the massage function of the driving device of the first assembly portion 11, users can hold the second handheld section 122. Due to the angular relationship between the second handheld section 122 and the first handheld section 121, users can better apply force and better control the strength of the massager pressed on the massage area. Similarly, when users use the additional massaging mechanism 200 assembled in the second assembly section 13 for massage, users can hold the first handheld section 121, thereby controlling the strength of the massager pressed on the massage area better. Furthermore, users can also grip the first handheld section 121 and the second handheld section 122 with both hands, which facilitates users with less strength to use the massager. In this embodiment, by the special design of the handheld portion 12 to be roughly L-shaped, users, whether using the massage function of the driving device of the first assembly section 11 or using the massage function of the additional massaging mechanism 200 assembled in the second assembly portion 13, can grip a single handheld section of the handheld portion 12 or grip the first and second handheld sections with both hands, which better satisfies users' need for stable grip of the massager and has a good effect of applying the force. Therefore, users can well control the strength of the massager pressed on the massage area, which effectively improves users’ experience.

In some embodiments, the housing 10 further includes a connecting section 14located on a side of the opening 102 of the angle between the first handheld section 121 and the second handheld section 122, i.e., the opening 102 of the angle of the L-shaped handheld portion 12 is directed towards the connecting section 14. Two opposite ends of the connecting section 14 are respectively connected to the first assembly portion 11 and the second assembly portion 13. Under such arrangement, the housing 10 forms an enclosed annular structure, allowing the overall structure of the housing 10 to be stronger and more solid. The connecting section 14 may have many shapes, such as a straight tube shape, a circular arc tube shape, a multi-segmented bent tube shape, etc. In the present embodiment, the connecting section 14 has a substantially straight tube shape.

Referring to FIG. 5, in some embodiments, the massager further includes at least one power supply assembly 60 used to supply power to the massager. The power supply assembly 60 can be arranged within the handheld portion 12 and/or within the connecting section 14. The power supply assembly 60 can be a battery (e.g. a lithium battery) or a dry cell battery. In the case where the housing 10 includes the L-shaped handheld portion 12 and the connecting section 14, the power supply assembly 60 can be arranged in the first handheld section 121 and the second handheld section 122 of the handheld portion 12, as well as in the connecting section 14. Thus, the power storage capacity of the massager is significantly increased, thereby allowing the usage duration of the massager to be significantly increased. Referring to FIG. 10, in some embodiments, the housing 10 is provided with a charging port 106 (USB port or Type-C port, etc.) for charging the power supply assembly in the housing 10.

The various technical features of the above embodiments may be combined in any combination, and for the sake of brevity of description, all possible combinations of the various technical features of the above embodiments have not been described, however, as long as there is no contradiction in the combinations of these technical features, they should be considered to be within the scope of the present specification as recorded herein.

The above is only some embodiments of the present disclosure, and is not intended to limit the scope of the present disclosure. Any equivalent structural transformations made under the concept of the present disclosure, utilizing the contents of the specification of the present disclosure and the accompanying drawings, or directly/indirectly applying them in other related technical fields, are all included in the scope of protection of the present disclosure.

What is claimed is:

1. A driving device for a massager, comprising: a bracket; a connecting rod mechanism, comprising a connecting rod seat, a driving connection rod, and a driven connection rod; wherein a rotation axis of the connecting rod seat is parallel to a second axial direction; a first end of the driving connection rod is rotatably connected to the connecting rod seat, a second end of the driving connection rod is rotatably connected to the driven connection rod, and an axis of each rotation node of the first end and the second end of the driving connection rod is parallel to the second axial direction; a power mechanism, arranged on the bracket and connected to the connecting rod seat for driving the connecting rod seat to rotate; and a swing rod mechanism, comprising at least two swing rods rotatably connected in sequence; wherein a front end of the swing rod mechanism is rotatably connected to the bracket, a rear end of the swing rod mechanism is rotatably connected to the driven connection rod, and an axis of each rotation node of the swing rod mechanism is parallel to a third axial direction;
wherein the power mechanism drives the connecting rod seat to rotate and thus drives the first end of the driving connection rod to rotate around the rotation axis of the connecting rod seat, thereby driving the driving connection rod to swing; under the driving action of the second end of the driving connection rod and the limiting action of the swing rod mechanism, the driven connection rod reciprocates in a first axial direction; and the first axial direction, the second axial direction, and the third axial direction are mutually perpendicular to each other.

2. The driving device according to claim 1, wherein the rotation axis of the connecting rod seat is in a same plane as the axis of the rotation node of the second end of the driving connection rod, and is parallel to the first axial direction; and/or
in the first axial direction, the rotation node of the second end of the driving connection rod is located directly behind the driven connection rod.

3. The driving device according to claim 1, wherein the driven connection rod comprises a connecting table arranged at an end of the driven connection rod close to the connecting rod seat and extending towards the connecting rod seat, and the second end of the driving connection rod is rotatably connected to the connecting table; and/or the driven connection rod comprises a step portion arranged on a side opposite to the rear end of the swing rod mechanism, and the rear end of the swing rod mechanism is rotatably connected to the step portion.

4. The driving device according to claim 1, wherein the swing rod mechanism further comprises another swing rod; or the driving device further comprises another swing rod mechanism and the two swing rod mechanisms are substantially symmetrically arranged on both sides of the driven connection rod respectively; and/or
the driven connection rod comprises an interface at an end of the driven connection rod away from the connecting rod seat for mounting a massage head.

5. The driving device according to claim 1, wherein the first end of the driving connection rod is rotatably connected to the connecting rod seat through a first bearing structure, the second end of the driving connection rod is rotatably connected the driven connection rod through the first bearing structure; the first bearing structure comprises a first bearing, a first bearing column, and a first bearing hole, all axes of which are arranged along the second axial direction; the first bearing is arranged in the first bearing hole, an outer ring of the first bearing is fixed to the first bearing hole, and the first bearing column is inserted in an inner ring of the first bearing and fixed to the inner ring of the first bearing; the first bearing column and the first bearing hole of the first bearing structure are arranged on two parts that are rotatably connected through the first bearing structure, respectively; and/or the swing rods of the swing rod mechanism are rotatably connected to each other through a second bearing structure, the front end of the swing rod mechanism and the bracket are rotatably connected through the second bearing structure, the rear end of the swing rod mechanism and the driven connection rod are rotatably connected through the second bearing structure; the second bearing structure comprises a second bearing, a second bearing column, and a second bearing hole, all axes of which are arranged along the third axial direction; the second bearing is arranged in the second bearing hole, an outer ring of the second bearing is fixed to the second bearing hole, and the second bearing column is inserted into an inner ring of the second bearing and is fixed to the inner ring of the second bearing; the second bearing column and the second bearing hole of the second bearing structure are arranged on the two parts that are rotatably connected through the second bearing structure, respectively.

6. The driving device according to claim 1, wherein the power mechanism comprises a motor fixedly connected to the bracket, an output shaft of the motor is arranged along the second axial direction, and the output shaft of the motor directly or indirectly drives the connecting rod seat to rotate.

7. The driving device according to claim 6, wherein the connecting rod seat is fixedly connected to the output shaft of the motor, the first end of the driving connection rod is rotatably connected to a side of the connecting rod seat away from the motor; or the connecting rod seat is integrally formed with the output shaft of the motor, and the first end of the driving connection rod is rotatably connected to a side of the connecting rod seat away from the motor; or the motor comprises a motor housing, the motor housing is fixedly connected to the output shaft, and the connecting rod seat is fixedly connected to or integrally formed with the motor housing; and the first end of the driving connection rod is rotatably connected to an end of the connecting rod seat away from the motor.

8. The driving device according to claim 7, wherein the motor is fixedly connected to one side of the bracket and the connecting rod seat is located on an opposite side of the bracket, and the output shaft of the motor extends through the bracket to be fixed to the connecting rod seat; or the motor and the connecting rod seat are arranged on the same side of the bracket.

9. The driving device according to claim 1, wherein the bracket comprises a base, and the front end of the swing rod mechanism is rotatably connected to the base.

10. A massager, comprising a housing and a driving device for the massager, wherein the driving device comprises: a bracket; a connecting rod mechanism, comprising a connecting rod seat, a driving connection rod, and a driven connection rod; wherein a rotation axis of the connecting rod seat is parallel to a second axial direction; a first end of the driving connection rod is rotatably connected to the connecting rod seat, a second end of the driving connection rod is rotatably connected to the driven connection rod, and an axis of each rotation node of the first end and the second end of the driving connection rod are parallel to the second axial direction; a power mechanism arranged on the bracket and connected to the connecting rod seat for driving the connecting rod seat to rotate; and a swing rod mechanism, comprising at least two swing rods rotatably connected in sequence; wherein a front end of the swing rod mechanism is rotatably connected to the bracket, a rear end of the swing rod mechanism is rotatably connected to the driven connection rod, and an axis of each rotation node of the swing rod mechanism is parallel to a third axial direction; wherein the power mechanism drives the connecting rod seat to rotate and thus drives the first end of the driving connection rod to swing around the rotation axis of the connecting rod seat; under the driving action of the second end of the driving connection rod and the limiting action of the swing rod mechanism, the driven connection rod reciprocates in a first axial direction; the first axial direction, the second axial direction, and the third axial direction are mutually perpendicular to each other; and the driving device is arranged in the housing, the bracket is fixed to the housing; the housing comprises an opening formed in one end thereof close to the driven connection rod, allowing a massage head to be mounted on the driven connection rod.

11. The massager according to claim 10, wherein the bracket and the housing are two separated parts; or, the bracket and the housing are integrally formed.

12. The massager according to claim 10, wherein the housing comprises a first assembly portion and a handheld portion, the driving device is arranged in the first assembly portion, and the opening is formed in the first assembly portion.

13. The massager according to claim 12, wherein the first assembly portion is arranged at one end of the handheld portion, and the housing is substantially shaped as a T or a cross; or the handheld portion comprises two handles substantially symmetrically arranged on both sides of the first assembly portion respectively, and the housing is substantially shaped as a T or a cross; and/or the massager further comprises an additional massaging mechanism arranged at an end of the first assembly portion away from the opening.

14. The massager according to claim 12, wherein the massager further comprises an additional massaging mechanism, the housing further comprises a second assembly portion for assembling the additional massaging mechanism, the first assembly portion and the second assembly portion are connected to two ends of the handheld portion respectively.

15. The massager according to claim 14, wherein the handheld portion comprises a first handheld section and a second handheld section connected and distributed in an L-shaped form, the first handheld section is connected to the first assembly portion, and the second handheld section is connected to the second assembly portion.

16. The massager according to claim 15, wherein the housing further comprises a connecting section located at a side of an opening of an angle formed between the first handheld section and the second handheld section, and two opposite ends of the connecting section are connected to the first assembly portion and the second assembly portion respectively.

17. The massager according to claim 14, wherein the additional massaging mechanism is arranged on the second assembly portion, the additional massaging mechanism comprises: a vibration device, fixedly connected to the second assembly portion; at least one massage portion, fixedly connected to the vibration device; and a shell, wrapped around the vibration device and fixedly connected to the vibration device or the second assembly portion; wherein an end of the massage portion away from the vibration device protrudes out of the shell.

18. The massager according to claim 17, wherein the massage portion comprises a fixing section and a massage section, the fixing section is fixedly connected to the vibration device, and the massage section is detachably connected to an end of the fixing section away from the vibration device; and/or the shell is fixedly connected to the vibration device and vibrates substantially synchronously with the vibration device.

19. The massager according to claim 18, wherein the additional massaging mechanism further comprises at least one rub piece arranged on an outer wall of the shell, and/or the second assembly portion further comprises at least one flexible vibration-damping member arranged between the shell and an end of the second assembly portion close to the shell, and the flexible vibration-damping member resiliently abuts the second assembly portion and the shell.

20. The massager according to claim 17, wherein the additional massaging mechanism further comprises a vibration damping mechanism; an avoidance opening is formed in a side of the shell facing the housing, the vibration damping mechanism is arranged in the avoidance opening; and the vibration device is fixedly connected to the second assembly portion through the vibration damping mechanism.
